(19) United States
(12) Patent Application Publication
(10) Pub. No.: US 2008/0291337 A1
(43) Pub. Date: Nov. 27, 2008

(54) Compact digital TV tuner unit

(75) Inventors: Nobuo Nakajima, Tokyo (JP); Koichi Gyoda, Tokyo (JP); Eiji Shibuya, Kobe-shi (JP); Takehiro Onomatsu, Osaka (JP); Hideto Yoshimura, Osaka (JP)

Correspondence Address: Yokoi & Co., U.S.A., Inc., 13700 Marina Pointe Drive #723, Marina Del Rey, CA, 90292, US

(73) Assignees: THE UNIVERSITY OF ELECTRO-COMMUNICATIONS, Tokyo (JP); Funai Electric Co., Ltd., Osaka (JP)

(21) Appl. No.: 12/152,980

(22) Filed: May 19, 2008

(30) Foreign Application Priority Data
May 22, 2007 (JP) JP2007-135605

(51) Int. Cl. H04N 5/50

(52) U.S. Cl. 348/731; 348/E05.097

(57) ABSTRACT

The present invention discloses a compact digital TV tuner unit mounted on an analog receiver equipped with an analog tuner, comprising: a boxy chassis; a terminal face of the chassis facing the analog receiver; an antenna input terminal that is placed on the terminal face and that is connected to an external antenna wire; an antenna output terminal that is placed on the terminal face adjacent to the antenna input terminal and that is connected to the analog receiver; and a converter circuit whose circuit elements are placed on a loop line starting at the antenna input terminal and ending at the antenna output terminal in the chassis and that converts digital broadcast signals input from the antenna input terminal to analog broadcast signals to output the analog broadcast signals to the antenna output terminal.

### CROSS-REFERENCES TO RELATED APPLICATIONS

The present application is related to the Japanese Patent Application No. 2007-135605, filed May 22, 2007, the entire disclosure of which is expressly incorporated by reference herein.

### BACKGROUND OF THE INVENTION

(1) Field of the Invention

The present invention relates to compact digital TV tuners unit and, more particularly, to a compact digital TV tuner unit mounted on an analog receiver equipped with an analog tuner.

(2) Description of the Related Art

Recently, with the introduction of terrestrial digital TV broadcasts, the demand for external digital TV tuner units has significantly grown in order to make good use of existing analog receivers equipped with analog tuners. For example, a set-top box type of digital TV tuner unit attached to analog receivers has been provided so that the analog receiver can receive images and sounds of terrestrial digital TV broadcasts. However, because the set-top box type of digital TV tuner unit needs a certain amount of installation space, the demand for small-sized digital TV tuner units has been increasing.

Japanese Unexamined Patent Application Publication (JP-A) No. 2002-57950 discloses a signal processing device equipped with a printed board on which both a receiving circuit and a regenerating circuit are high densely mounted in order to meet the above mentioned demand.

In the circuits of the device disclosed by JP-A-2002-57950, an input terminal to receive antenna signals and an output terminal to output image signals and sound signals are placed opposite to each other with the body of the device between them. Therefore, if it is assumed that the signal processing device is fixed to an analog receiver by connecting the output terminal to the analog receiver, the vibration of an antenna wire connected to the input terminal puts a stress on the output terminal placed on the opposite side of the signal processing device, with the result that the output terminal has a potential to be damaged. In addition, the antenna input terminal is placed inevitably on the far side of the signal processing device seen from the analog receiver. Therefore, there is a problem in that if the signal processing device is put in the rear of the analog receiver, a certain amount of space in the rear of the analog receiver is needed for the signal processing device. Although Japanese Utility Model Registration Application No. 3096172, JP-A-2006-157378, and JP-A-2006-79778 disclose some examples of circuit constitutions for tuner units, it is difficult to say that they have succeeded in downsizing of the tuner units and reducing spaces needed to connect the tuner units to the analog receiver.

To address the above-mentioned problems, the present invention aims at providing a compact digital TV tuner unit that has excellent characteristics of downsizing, and space-saving and high reliability of its connection to an analog receiver.

### BRIEF SUMMARY OF THE INVENTION

The present invention discloses a compact digital TV tuner unit mounted on an analog receiver equipped with an analog tuner, comprising: a boxy chassis; a terminal face of the chassis facing the analog receiver; an antenna input terminal that is placed on the terminal face and that is connected to an external antenna wire; an antenna output terminal that is placed on the terminal face adjacent to the antenna input terminal and that is connected to the analog receiver; and a converter circuit whose circuit elements are placed on a loop line starting at the antenna input terminal and ending at the antenna output terminal in the chassis and that converts digital broadcast signals input from the antenna input terminal to analog broadcast signals to output the analog broadcast signals to the antenna output terminal.

These and other features, aspects, and advantages of invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and the drawings are to be used not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

FIG. 1 is a perspective view of a compact digital TV tuner unit;

FIG. 2 is an exploded perspective view of the compact digital TV tuner unit;

FIG. 3 is a view showing the locations of circuits and a ROM and a RAM included in the converter circuit;

FIG. 4 is a view showing the compact digital TV tuner unit attached to an analog TV set; and

FIG. 5 is a view showing the locations of circuits and a ROM and a RAM included in a converter circuit in accordance with a modified example.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

The embodiments of the present invention will be described in the following order.

A. First embodiment

B. Modification

### A. First Embodiment

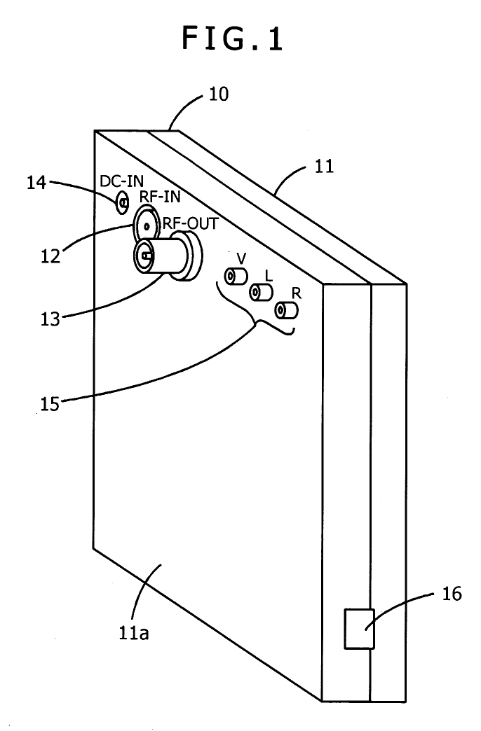

FIG. 1 is a perspective view of a compact digital TV tuner unit in accordance with a first embodiment of the present invention. In FIG. 1, the compact digital TV tuner unit 10 has a boxy chassis 11. The chassis 11 has a terminal face 11a. An antenna input terminal 12 and an antenna output terminal 13 are placed in parallel with each other on the terminal face 11a, wherein the axial directions of both antenna input terminal 12 and antenna output terminal 13 are perpendicular to the terminal face 11a. The antenna input terminal 12 is a female terminal that can be connected to a coaxial antenna line, and the antenna output terminal 13 is a male terminal suitable for a coaxial antenna.

It should be noted that these terminals may be of other types of terminals or may be various types of terminals according to specifications and destinations, one of which, for example, is SCART terminals widely used in Europe. The antenna input terminal 12 and the antenna output terminal 13 are placed on the upper part of the terminal face 11a. In addition, a power terminal 14 into which a DC voltage is input from an external power adapter and composite output terminals 15 including a left audio terminal, a right audio terminal and a video terminal are placed near the antenna input terminal 12 and the antenna output terminal 13. In the boxy chassis 11, an optical remote-control signal receiving module 16 with its sensor window exposed outside is placed on a side face perpendicular to the terminal face 11a.

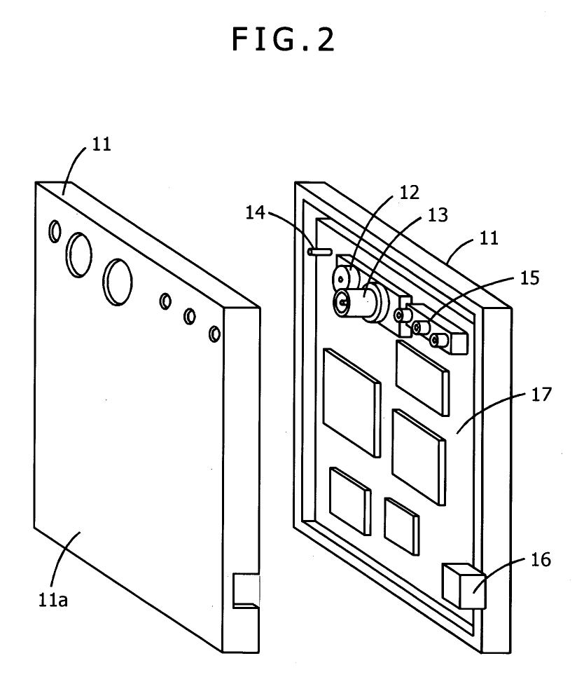

FIG. 2 is an exploded perspective view of the compact digital TV tuner unit 10. As shown in FIG. 2, the compact digital TV tuner unit 10 has a printed board, 17 parallel with the terminal face 11a. The antenna input terminal 12, the antenna output terminal 13, the power terminal 14 and the composite output terminals 15 are placed on the upper part of the printed board 17 in such a way that the axial directions of the above terminals are perpendicular to the printed board 17. When the chassis 11 are folded, the above mentioned terminals are put out their receptacles outside, so that these terminals can be connected to individual outside counterparts.

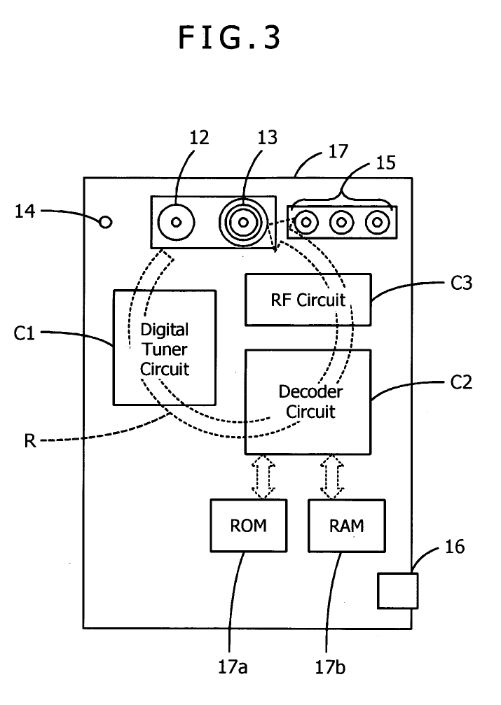

FIG. 3 is a view showing the locations of individual integrated circuits mounted on the printed board 17. Circuits to mount the above mentioned terminals are formed on the upper part of the printed board 17. A digital tuner circuit C1 is placed directly below the antenna input terminal 12. The digital tuner circuit C1 selects a frequency band based on remote-control signals input through the optical remote-control signal receiving module 16, and demodulates broadcast signals through amplifying and detecting the broadcast signals within the frequency band to generate digital signals. In addition, the digital tuner circuit C1, which is equipped with a demultiplexing circuit for demultiplexing multiplexed signals and a descrambling circuit for decrypting encrypted digital signals, outputs demultiplexed and decrypted digital signals to a subsequent decoder circuit C2.

The decoder circuit C2 decompresses compressed input digital data. Below the decoder circuit C2, provided are the ROM 17a and RAM 17b. ROM 17a stores programs used by the decoder circuit C2. The processor in the decoder circuit C2 carries out operations according to the programs while recording temporary data on the RAM 17b to decode and decompress the compressed input digital data. The decoding needs a lot of arithmetic processing, so the RAM 17b is used therein that is capable of high speed reading/writing operations.

The decoder circuit C2, which is also equipped with a DA converter circuit, converts the decompressed digital video signals and digital audio signals into analog video signals and analog audio signals of prescribed formats respectively and outputs them to the subsequent composite output terminals 15 and a subsequent RF circuit C3. For example, the decompressed digital video signals are converted into the analog video signals compatible with NTSC or PAL. The decoder circuit C2 generates composite video signals consisting of luminance signals and color signals in addition to the analog video signals.

The RF circuit C3, which is placed above the decoder circuit C2, receives the analog video signals and the analog audio signals compatible with NTSC or PAL from the decoder circuit C2 below the RF circuit C3 (FIG. 3). The RF circuit C3 modulates the analog video signals and the analog audio signals into predefined carrier frequencies thereby to generate analog broadcast signals. For example on VHF band (for Japan), the analog video signals and the analog audio signals are modulated into frequencies allocated to the first or second channel.

The video signals and audio signals are modulated into separate carrier frequencies respectively to thereby superimpose both signals on the broadcast signals for their transmission. The modulated analog broadcast signals are output through the antenna output terminal 13 above the RF circuit C3 to an external analog receiver. On the other hand, the composite video signals and the analog audio signals generated by the decoder circuit C2 are input to the composite output terminal 15 placed in parallel with the antenna output terminal 13 and are output to the outside as they are through the composite output terminal 15.

As for the above mentioned configuration of the circuits and terminals, it can be said that the antenna input terminal 12, the digital tuner circuit C1, the decoder circuit C2, the RF circuit C3 and the antenna output terminal 13 are placed on a loop line R indicated by dotted lines in FIG. 3. The loop line R starts at the antenna input terminal 12 and ends at the antenna output terminal 13 in the counterclockwise direction. Incidentally, the loop line R is a virtual line for convenience of explanation of the locations of the above mentioned circuits. In reality the individual circuits are connected to each other with the shortest (linear) printed wiring.

Because the end of the loop line R falls on the vicinity of the start of the loop line R, the antenna output terminal 13 can be placed in the vicinity of the antenna input terminal 12. Because the circuits are placed on the loop line R in this way, the length of the printed board 17 can be formed shorter than the case where the circuits are placed on a straight line, with the result that the chassis 11 can be formed in a compact size. In addition, because the ROM 17a and RAM 17b below the decoder circuit C2 are placed outside the loop line R, the radius of the loop line R can be made smaller than the case where the ROM 17a and RAM 17b are placed inside the loop line R, with the result that the length of the printed wires can be reduced.

Because the ROM 17a and the RAM 17b are placed away from the antenna output terminal 13 through which analog signals are transmitted, adverse effects of noises generated by high speed read/write operations in the ROM 17a and the RAM 17b on the video and audio signals can be also eradicated. Because the area of the printed board 17 within the loop line R is parallel with the terminal plane 11a, the thickness of the chassis 11 in the axis direction of the antenna output terminal 13 can be made thin.

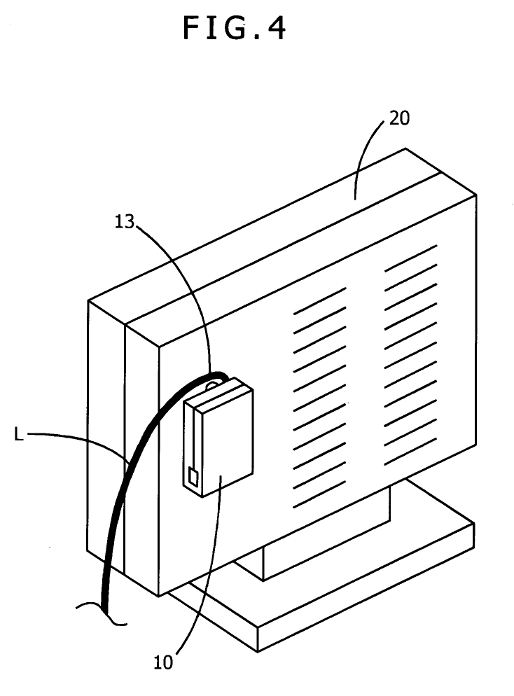

FIG. 4 is a view showing the compact digital TV tuner unit 10 attached to the analog TV set that acts as an analog receiver with an analog tuner embedded. On the rear of the analog TV set 20, provided is a female terminal into which a coaxial antenna line is plugged. Plugging the antenna output terminal 13 into the female terminal can fix the compact digital TV tuner unit 10 to the analog TV set 20. It is necessary to plug an antenna line L connected to an external antenna into the antenna input terminal 12 before attaching the compact digital TV tuner unit 10 to the analog TV set 20.

It should be noted that in addition to any other attaching mechanism used to fix the compact digital TV tuner unit 10 to the analog TV set 20, electrical connecting means of the output terminal 13 may also be used for such fixing. Because the antenna output terminal 13 is perpendicular to the terminal face 11a, the terminal face 11a is almost in parallel with the rear of the analog TV set 20. Because the thickness of the chassis 11 is thin in the axis direction of the antenna output terminal 13 that is perpendicular to the terminal face 11a, the compact digital TV tuner unit 10 can be easily fixed to the analog TV set 20 even if there is not much space behind the rear of the analog TV set 20. In addition, the configuration that permits of less possibility that something will get stuck with the compact digital TV tuner unit 10 will prevent the compact digital TV tuner unit 10 from being damaged.

The antenna line L, which may be stretched from wall to wall when in use, is expected to be accidentally pulled. In such a case, a stress is put on the antenna input terminal 12 connected to the antenna line L, but because the antenna input terminal 12 is placed near the antenna output terminal 13, the moment of force that is put on the antenna output terminal 13 through the chassis 11 can be made small. Therefore, the stress put on the connection between the antenna output terminal 13 and the analog TV set 20 can be reduced, making it possible to reliably connect the antenna output terminal 13 to the analog TV set 20. If the analog tuner embedded in the analog TV set 20 is set to receive the first channel or second channel, the analog TV set 20 can receive the analog broadcast signals generated by the compact digital TV tuner unit 10 and can regenerate images and sounds.

A channel received by the tuner circuit C1 of the compact digital TV tuner unit 10 can be specified under the control of a remote-control signal, making it possible for a viewer to select his/her desired channel with a remote controller. Incidentally, where the analog TV set 20 is equipped with composite input terminals, connecting an RCA cable between the composite input terminals and the composite output terminal 15 and switching the analog TV set 20 to the external (video) input mode make it possible to watch digital broadcast TV programs on the analog TV set 20.

### B. Modification

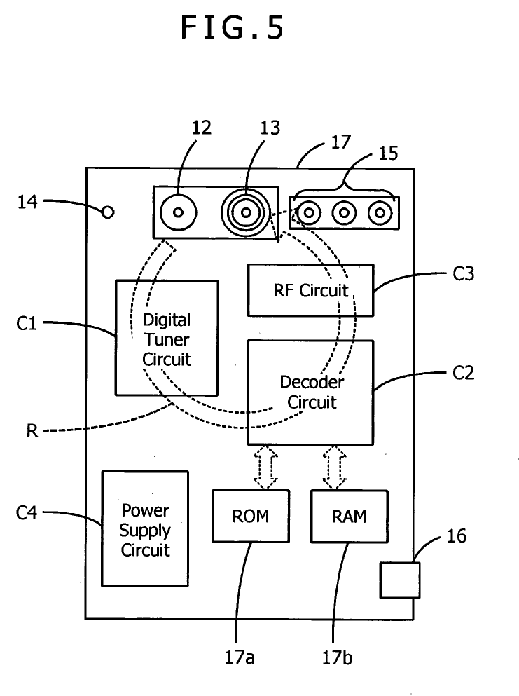

Although the above mentioned embodiment described that DC power is supplied to the compact digital TV tuner unit 10 by an external power adaptor, commercial AC power may be directly supplied to the compact digital TV tuner unit 10. FIG. 5 shows the compact digital TV tuner unit 10 that is equipped with a power supply circuit that converts AC power into DC power. In FIG. 5, a power supply circuit C4 is placed outside the loop line R on the lower part of the printed board 17. The power supply circuit C4 includes a rectifier circuit, a voltage regulator circuit and a voltage stabilizer circuit. Locating these circuits far away from the RF circuit C3 and the antenna output terminal 13 through which analog signals are transmitted prevents noises from getting mixed with images and sounds. It should be noted that the AC cable of the power supply circuit C4 is expected to be accidentally pulled, so it is desirable that the AC cable is drawn into the chassis 11 through a hole near the connection between the antenna output terminal 13 and the analog TV set 20.

In the present invention configured as mentioned above, the compact digital TV tuner unit includes a boxy chassis, in which the components for the compact digital TV tuner unit are provided. A terminal face of the compact digital TV tuner unit is placed on a face of the chassis facing the analog receiver, and an antenna input terminal connected to an external antenna wire is mounted on the terminal face. In addition, an antenna output terminal connected to the analog receiver is mounted on the terminal face in parallel with the antenna input terminal. Because the antenna output terminal and the antenna input terminal are mounted on the terminal face facing the analog receiver, even when the external antenna wire connected to the antenna input terminal vibrates, the vibration of the connection between the antenna output terminal and the analog receiver can be reduced. In addition, the converter circuit, which converts digital broadcast signals input from the antenna input terminal to analog broadcast signals to output the analog signals to the antenna output terminal, is provided in the chassis, wherein the components of the converter circuit are placed on a loop line that starts at the antenna input terminal and ends at the antenna output terminal in the chassis. Therefore, the converter circuit can be formed in a compact size, with the result that the noise can be reduced owing to the short total length of wires that connect the components.

In one aspect of the present invention, a configuration where a RAM and a ROM used by the converter circuit are placed outside the loop line is adopted. Therefore, the RAM and the ROM, which are apt to generate interference noises through high speed data transmission, can be kept away from the antenna output terminal which is connected to the output of the converter circuit and through which analog signals are transmitted, so that analog noises can be reduced. By locating the RAM and the ROM outside the loop line, the radius of the loop line can be made small and the total length of the wires that connect the components of the converter circuit can be made shorter.

In another aspect of the present invention, while the terminal face and the loop line are placed in parallel, the axial directions of both antenna input terminal and antenna output terminal are configured to be perpendicular to the terminal face and the loop line. The loop line is placed in parallel with the terminal face facing the analog receiver, so that the converter circuit can be placed in parallel with the rear of the analog receiver. Therefore, the chassis can be installed in parallel with the rear of the analog receiver, which results in space-saving.

In another aspect of the present invention, the converter circuit is so configured as to include a digital tuner module that is placed in the chassis and that receives the digital broadcast signals input through the antenna input terminal and generates digital signals; a decoder module that is placed in the chassis and that decodes the digital signals to convert the digital signals to analog signals with the use of the RAM and ROM; and an RF module that is placed in the chassis and that modulates the analog signals to generate analog broadcast signals that are output to the antenna output terminal. In other words, the digital tuner module, the decoder module and the RF module, which are provided as the components of the converter circuit, are placed on the loop line in the chassis. The RAM and the ROM are used for decoding processing and the like in the decoder module.

In addition, in another aspect of the present invention, a power supply circuit of the compact digital TV tuner unit is placed outside the loop line. If the power supply circuit is equipped with a DC conversion function, the power supply circuit can be a noise source. Therefore, it is desirable to locate the power supply circuit outside the loop line.

The present invention can be realized in a compact digital TV tuner unit in which the above mentioned configurations are brought in. As a concrete example of the present invention, a compact digital TV tuner unit mounted on an analog receiver equipped with an analog tuner includes a boxy chassis; a terminal face of the chassis facing an analog receiver; an antenna input terminal that is placed on the terminal face and that is connected to an external antenna wire; an antenna output terminal that is placed on the terminal face in parallel with the antenna input terminal and that is connected to the analog receiver; a digital tuner module that is placed in the chassis and that receives the digital broadcast signals input through the antenna input terminal to generate digital signals; a decoder module that is placed in the chassis and that decodes the digital signals to convert the demodulated digital signals to analog signals; and an RF module that is placed in the chassis and that modulates the analog signals to generate analog broadcast signals that are output to the antenna output terminal.

In addition, in this case, the digital tuner module, the decoder module and the RF module are placed in this order on a loop line that starts at the antenna input terminal and ends at the antenna output terminal in the chassis; a power supply circuit of the compact digital TV tuner unit, a RAM and a ROM used by the decoder module are placed outside the loop line; and the axial directions of both antenna input terminal and antenna output terminal are perpendicular to the terminal face and the loop line that are placed in parallel.

Although the invention has been described in considerable detail in language specific to structural features or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. For example, the inductors can be hollow tubular coils. Such variations and alternate embodiments are contemplated, and can be made without departing from the spirit and scope of the invention.

It is to be understood that the phraseology and terminology employed herein, as well as the abstract, are for the purpose of description and should not be regarded as limiting.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

What is claimed is:

1. A compact digital Television (TV) tuner unit mounted on an analog receiver equipped with an analog tuner, comprising:
a rectangular boxy chassis;
a terminal face of the chassis facing the analog receiver;
an antenna input terminal that is placed on the terminal face, and is connected to an external antenna wire;
an antenna output terminal that is placed on the terminal face adjacent to the antenna input terminal, and is connected to the analog receiver; and
a converter circuit with circuit elements that are placed on a loop line starting at the antenna input terminal and ending at the antenna output terminal in the chassis;
the converter circuit converts digital broadcast signals input from the antenna input terminal to analog broadcast signals to output the analog broadcast signals to the antenna output terminal.

2. The compact digital TV tuner unit as set forth claim 1, wherein a RAM and a ROM used by the converter circuit are placed outside the loop line.

3. The compact digital TV tuner unit as set forth claim 1, wherein
the terminal face is parallel with the loop line; and
the axial directions of both antenna input terminal and antenna output terminal are perpendicular to the terminal face and the loop line.

4. The compact digital TV tuner unit as set forth claim 1, wherein the circuit elements of the converter circuit comprising:
a digital tuner module that is placed in the chassis and that receives digital broadcast signals input through the antenna input terminal and that generates digital signals;
a decoder module that is placed in the chassis and that decodes the digital signals to convert the digital signals to analog signals with the use of the RAM and the ROM; and
an RF module that is placed in the chassis and that modulates the analog signals to generate analog broadcast signals that are output to the antenna output terminal.

5. The compact digital TV tuner unit as set forth claim 1, wherein a power supply circuit of the compact digital TV tuner unit is placed outside the loop line.

6. A compact digital Television (TV) tuner unit mounted on an analog receiver equipped with an analog tuner, comprising:
a rectangular boxy chassis;
a terminal face of the chassis facing the analog receiver;
an antenna input terminal that is placed on the terminal face, and is connected to an external antenna wire;
an antenna output terminal that is placed on the terminal face in parallel with the antenna input terminal, and is connected to the analog receiver;
a digital tuner module that is placed in the chassis and that receives digital broadcast signals input through the antenna input terminal to generate digital signals;
a decoder module that is placed in the chassis and that decodes the digital signals to convert the demodulated digital signals to analog signals; and
an RF module that is placed in the chassis and that modulates the analog signals to generate analog broadcast signals that are output to the antenna output terminal,
the digital tuner module, the decoder module, and the RF module are placed on a loop line starting at the antenna input terminal and ending at the antenna output terminal in the chassis;
a power supply circuit of the compact digital TV tuner unit, a RAM and a ROM used by the decoder module are placed outside the loop line; and
the axial directions of both antenna input terminal and antenna output terminal are perpendicular to the terminal face and the loop line that are placed in parallel.
